(19) United States
(12) Patent Application Publication
(10) Pub. No.: US 2025/0303431 A1
(43) Pub. Date: Oct. 2, 2025

(54) ULTRASONIC MISTING NOZZLE AND SYSTEM

(71) Applicant: Prodew, Inc., Marietta, GA (US)

(72) Inventors: Itamar KLEINBERGER, Marietta, GA (US); Shakeel MERCHANT, Brookhaven, GA (US); Faizan ALY, Smyrna, GA (US); Paul WILHELM, Roswell, GA (US); Roland BILODEAU, Canton, GA (US); Mikhail MOROZOV, Marietta, GA (US)

(21) Appl. No.: 19/098,602

(22) Filed: Apr. 2, 2025

Related U.S. Application Data
(60) Provisional application No. 63/573,215, filed on Apr. 2, 2024.

(51) Int. Cl. B05B 17/06; B05B 1/10

(52) U.S. Cl. CPC B05B 17/0615; B05B 1/10; B05B 17/0676

(57) ABSTRACT

A mist is generated by an ultrasonic misting nozzle device including an ultrasonic transducer, a control unit, and a housing. The control unit operates to control the ultrasonic transducer. The housing includes a liquid inlet, a drain outlet, a mist opening, and a collection chamber. The liquid inlet is connected to the collection chamber bottom periphery, the drain outlet connects to the collection chamber top, and the collection chamber bottom is adjacent and above the ultrasonic transducer, which is adjacent and above the mist opening. In example embodiments, the collection chamber is tapered with a larger bottom than top, and the liquid inlet has a smaller cross-sectional area than the drain outlet. Systems of the misting devices include low-voltage electric power wiring to each of the control units, a feed line connected to the liquid inlets under positive pressure, and/or common supply and drain lines for all the misting devices.

### CROSS-REFERENCE TO RELATED APPLICATION

This application claims the priority benefit of U.S. Provisional Patent Application Ser. No. 63/573,215 filed Apr. 2, 2024, the entirety of which is hereby incorporated herein by reference for all purposes.

### TECHNICAL FIELD

The present invention relates generally to the field of misting to humidify/hydrate perishables, and more particularly to such misting using ultrasonic nozzles.

### BACKGROUND

A variety of systems and methods are used to humidify/hydrate perishables in supermarkets and grocery stores, for example in meat, seafood, and produce display cases. Traditional systems and methods include using a water hose with a nozzle, or a spray bottle, to hand spray the perishables. Other systems and methods include mounting a number of nozzles connected to delivery pipes, with water under pressure supplied to the nozzles located at/in the display cases, resulting in a fine mist of about 100-micron droplets. These mounted-nozzle systems are commonly known as misting systems. Some misting systems include nozzles with air and water both under pressure, to create a very fine fog mist of about 6-micron to about 15-micron droplets. Some other fog-misting systems include centralized ultrasonic nebulizers that are similar to home cold humidifiers, with a water reservoir and an ultrasonic transducer located within the water reservoir. In these ultrasonic fog misting systems, the transducer operates at high frequencies to generate a fog mist that emanates upward from the top of the water level and is transported by piping to the delivery pipes, which includes holes (nozzles) to deliver the fog mist to the cases. And some other fog misting systems include vibratory mesh ultrasonic

There are several drawbacks to these ultrasonic fog misting systems, for example, safety, cost/time, coverage area, space, and water usage. As for safety, these ultrasonic fog misting systems include a reservoir of standing water, as well as standing water in the delivery pipes. These are potential breeding grounds for bacteria that when inhaled can cause serious health issues. This includes the Legionella bacteria, which causes Legionnaires' disease, with many people around the world having died from inhaling 2-3 micron size fog-mist droplets containing this bacteria (see, e.g., articles: https://www.cdc.gov/legionella/about/index.html and https://www.cdc.gov/legion ella/about/causes-transmission.html). It's possible to prevent/limit the growth of the Legionella and other bacteria. For example, some ultrasonic fog-misting systems include a mechanism that drains the open reservoir a few times a day, and others include an elaborate reverse-osmosis water-filtering system. But these preventive systems are mechanical, so they can (and do) fail, which is why some European countries have banned these types of systems. Also, these preventive systems require significant maintenance time and cost, and they waste a lot of water and energy.

As for cost/time, the equipment and its installation are very costly; depending on the system, this could run to $15,000 or even much higher. Also, the maintenance is very costly and needs to be performed by highly trained technicians; this maintenance could be around $5,000 per year. For many such systems, the main reservoir/transducer unit cannot be maintained on site and must be sent to the manufacturer's facility for yearly maintenance or replacement of the ultrasonic transducer, which involves significant added costs for shipping and labor, as well as the opportunity cost of a lengthy downtime.

As for coverage area, the fog mist of these ultrasonic systems (FMUS) moves in a very slow cascading flow, so the fog mist has a smaller target coverage area. Also, because of this slow cascading flow, any air movement in or near the case can disrupt the flow of the fog mist to the target area intended to be humidified. Further, for vertical display cases, the fog simply cannot reach the lower shelves of the cases.

As for space, the equipment of these ultrasonic systems takes up a lot of space and has a fairly large footprint. This can be an issue in many stores with limited floorspace.

And as for water usage, these ultrasonic systems use large amounts of water. Published water consumption specifications for these systems do not always include the water that must be dumped to refresh the reservoir, so actual water usage is typically higher than indicated in the specifications.

Accordingly, it can be seen that needs exist for improved misting systems. It is to the provision of solutions to this and other problems that the present invention is primarily directed.

### SUMMARY

Generally described, the present invention relates to devices, systems, and methods of generating a mist of liquid droplets and directing it toward a target area for humidification. The mist is generated by an ultrasonic misting nozzle device including an ultrasonic transducer, a control unit, and a housing. The control unit operates to control the ultrasonic transducer. The housing includes a liquid inlet, a drain outlet, a mist opening, and a collection chamber. The liquid inlet is connected to the collection chamber bottom periphery, the drain outlet connects to the collection chamber top, and the collection chamber bottom is adjacent and above the ultrasonic transducer, which is adjacent and above the mist opening.

In operation, a liquid (e.g., water) flows under pressure from the liquid inlet line discharge and into the collection chamber bottom. The ultrasonic transducer operates to induce a gas (e.g., air) to flow upward into the mist opening, through the ultrasonic transducer, and into the collection chamber. Also, the ultrasonic transducer generates gas (e.g., air) bubbles in the collection chamber bottom and generates and emits the mist (e.g., fog) downward out of the collection chamber through the ultrasonic transducer and the mist opening. The liquid (e.g., water) flows under pressure across and atop the ultrasonic transducer to displace the gas (e.g., air) bubbles from atop the ultrasonic transducer and mix with the gas bubbles to form a gas-infused liquid (e.g., aerated water) that flows upward within the collection chamber, away from the ultrasonic transducer, towards the drain outlet, and out of the collection chamber through the drain outlet.

In example embodiments, the collection chamber is tapered with a larger bottom than top, and the liquid inlet has a smaller cross-sectional area than the drain outlet. Systems of the misting devices include low-voltage electric power wiring to each of the control units, a feed line connected to the liquid inlets under positive pressure, and/or common supply and drain lines for all the misting devices.

These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of an ultrasonic misting device according to an example embodiment of the present invention.

FIG. 2 is a front view of the ultrasonic misting device of FIG. 1.

FIG. 3 is an exploded perspective view of the ultrasonic misting device of FIG. 1.

FIG. 4 is a front cross-sectional view of the ultrasonic misting device of FIG. 1.

FIG. 5 shows the ultrasonic misting device of FIG. 4 in use with water and air flowing through it to produce mist.

FIG. 6 is a perspective view of an ultrasonic misting module including the ultrasonic misting device of FIG. 1.

FIG. 7 is a top view of the ultrasonic misting module of FIG. 6.

FIG. 8 is a front view of the ultrasonic misting module of FIG. 6.

FIG. 9 is an end view of the ultrasonic misting module of FIG. 6.

FIG. 10 is a rear view of the ultrasonic misting module of FIG. 6, with some components removed for clarity, shown in use with water and air flowing through it to produce mist.

FIG. 11 is a detail view of a portion of the ultrasonic misting module of FIG. 10, shown in cross section, and shown in use with water and air flowing through it to produce mist.

FIG. 12 is a schematic diagram of an ultrasonic misting system according to an example embodiment and including a plurality of the ultrasonic misting modules of FIG. 6, shown in use with water and air flowing through it to produce mist.

FIG. 13 is a detail view of a portion of the ultrasonic misting system of FIG. 12, showing example components of the system.

FIG. 14 is a schematic diagram of an open-loop ultrasonic misting system according to another example embodiment and including a plurality of the ultrasonic misting modules of FIG. 6, shown in use with water and air flowing through it to produce mist.

FIG. 15 is a schematic diagram of a closed-loop ultrasonic misting system according to another example embodiment and including a plurality of the ultrasonic misting modules of FIG. 6, shown in use with water and air flowing through it to produce mist.

### DESCRIPTION OF EXAMPLE EMBODIMENTS

Generally described, the present invention relates to ultrasonic misting devices and systems for delivering fine droplets of liquid to perishables. The misting devices and systems are described herein primarily with reference to generating and delivering a mist of water droplets to provide humidification (including hydration) to perishables (e.g., meat, seafood, produce, cheese, deli products, and/or flowers, etc.) in storage areas (e.g., supermarket display cases for purchase, storage rooms in supermarkets or warehouses, intermodal containers for transport, etc.). It will be understood that the misting devices and systems can be used as described herein, and/or adapted for use as known by persons of ordinary skill in the field, for use in delivering water, a disinfectant, another liquid, and/or a combination thereof, to provide humidification, disinfection, and/or other misting, to perishables, living beings (including humans), and/or other targets, in display, storage, passenger, and/or other target areas, in the same or other applications. Such other applications can include for example aviation (e.g., aircraft passenger cabins), cruise ships (e.g., all occupied spaces), trains and buses, retail stores, HVAC systems (equipment and/or ductwork), healthcare (e.g., waiting rooms, operating rooms, and/or patient rooms), pharmaceuticals, manufacturing (e.g., rooms where electronic devices are manufactured), and/or agriculture (e.g., poultry egg production facilities). Accordingly, various embodiments of the ultrasonic misting devices and systems use water and/or another liquid (e.g., a disinfectant and/or hypochlorous acid), in combination with air or another gas (e.g., ozone, for disinfection and odor control), to provide the described misting functionality (as such, water and liquid are sometimes used interchangeably herein, and air and gas are sometimes used interchangeably herein). An example of hypochlorous acid currently sold under the brand name PRODUCE MAXX by Chemstar (Lithia Springs, GA), used with their SAFEMIST brand system, an add-on option to misting systems.

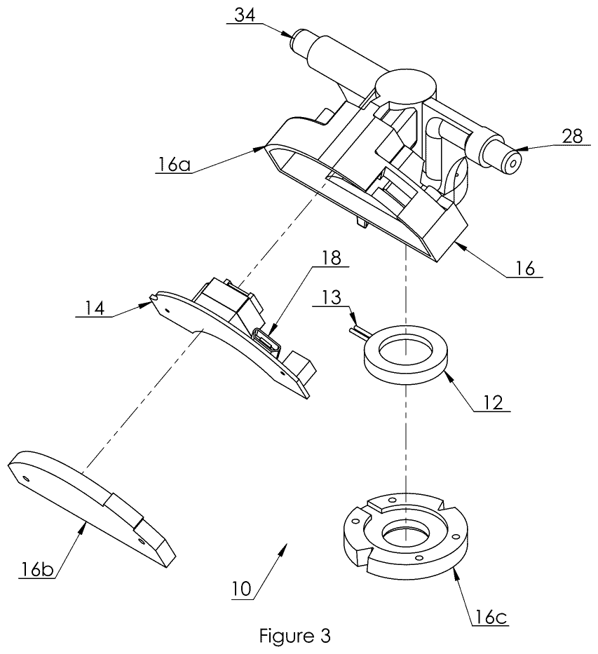

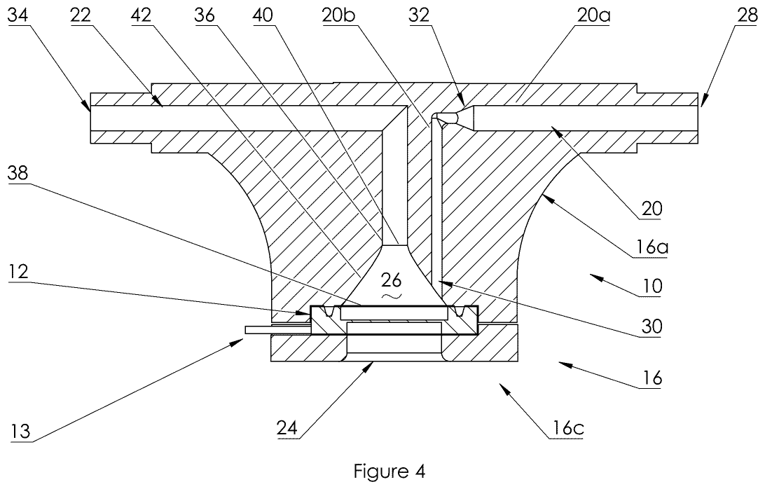

Turning now to the drawings, FIGS. 1-5 show an ultrasonic misting nozzle device 10 according to an example embodiment of the invention. The misting device 10 includes an ultrasonic transducer 12, a control unit 14, and a housing 16. These components can be made of conventional materials using conventional fabrication techniques and equipment, as is known in the field.

The ultrasonic transducer 12 in typical embodiments is a vibrating-mesh ultrasonic transducer. Such vibrating-mesh ultrasonic transducers 12 include a perforated sheet of metal or other material positioned within a peripheral piezoelectric element with an electrical connection 13. The electrical connection 13 is electrically connected to the control unit 14 so that the ultrasonic transducer 12 is powered and controlled by the control unit 14. In the depicted embodiment, the perforated sheet is circular and the peripheral piezoelectric element is annular (peripherally surrounding the perforated sheet), with the vibrating-mesh ultrasonic transducer 12 thus being disc-shaped (and thus sometimes referred to as a metal mesh disc). Such vibrating-mesh ultrasonic transducers 12 atomize the liquid 4 to generate a fine mist cloud of water droplets 8, with each droplet having a diameter of for example about 2 microns to about 15 microns, about 2 microns to about 6 microns, or typically about 3 microns to about 5 microns (e.g., with a vibrating frequency of about 108 KHz to about 113 KHz). Vibrating-mesh ultrasonic transducers 12 of this type are conventional and commercially available for example from TEKCELEO (Mougins, France).

In other embodiments, the ultrasonic transducer 12 is other than a vibrating-mesh type, for example an immersion or contact ultrasonic transducer, another type of piezoelectric or capacitive ultrasonic transducer, or another type of transmitter (or transceiver) ultrasonic transducer, provided that it includes perforations configured to permit the air 6 and mist 8 to flow through it to provide the pass-through functionality described herein (e.g., this expressly excludes horn-type ultrasonic transducers). And in other embodiments, the ultrasonic transducer 12 is other than disc-shaped, for example it can have a rectangular, polygonal, or other regular or irregular shape.

The control unit 14 in typical embodiments is a printed circuit board (PCB) with an electrical connection 18. The PCB provides controls, including power on/off and typically a timer for on/off intervals. The PCB can be of a conventional type that is commercially available from numerous suppliers. In other embodiments, other types of conventional or future-developed control components can be provided. The electrical connection 18 can be connected to by wiring (e.g., to a 5 vDC power supply) to power the control unit 14 and thus the ultrasonic transducer 12. In other embodiments, the control unit is not local/individual to the ultrasonic transducer 12 and part of the device 10, and instead a centralized control unit is located remote from the device 10 for group control of a system of the devices 10.

The housing 16 includes a liquid inlet line 20, liquid drain line 22, and a bottom opening 24, with a collection chamber 26 in fluid communication with all three of these, with the ultrasonic transducer 12 positioned below the collection chamber 26 and above the bottom opening 24. Also, an on/off power switch can be provided on the housing 16 and wired to the control unit 14 so that each misting device 10 (e.g., in a system including a plurality of them) can be independently manually turned on and off. The housing 16 can include multiple body components that collectively define the water inlet line 20, the liquid drain line 22, the bottom opening 24, and the collection chamber 26. For example, the housing 16 can include a main body 16a that defines the water inlet line 20 and the liquid drain line 22, a cover panel 16b that connects to the main body 16a to enclose the control unit 14 within the main body 16a, and a bottom panel 16c that connects to the main body 16a and defines the bottom opening 24.

The bottom panel 16c includes the bottom opening 24 in alignment with the ultrasonic transducer 12 to expose the perforated sheet of the ultrasonic transducer 12 and thereby allow air (or another gas) 6 to enter through the bottom opening 24 and thus the ultrasonic transducer 12. As such, the bottom panel 16c can be a clamp ring (e.g., as depicted) that connects to the main body 16a, sandwiching the ultrasonic transducer 12 between them to secure it in place and create a seal, as depicted. Alternatively, the bottom panel can simply be fasteners (e.g., clamps, clips, screws, etc.) that connect the ultrasonic transducer 12 to the main body 26a to provide the described functionality, with more of the ultrasonic transducer 12 exposed, and with the bottom opening formed by the void space centrally located between the fasteners. In any event, the bottom opening 24 typically has a size (e.g., diameter or other transverse dimension) that is larger than that of the perforated sheet of the ultrasonic transducer 12, a shape (e.g., circular) that conforms to that of the perforated sheet of the ultrasonic transducer 12, or both.

In other embodiments of the housing, the liquid inlet line and the liquid drain line can be provided by tubing connected to a hollow body forming the collection chamber (with these separate components all enclosed within the housing), and/or the bottom opening can be defined by the portion of the housing adjacent the bottom of the ultrasonic transducer. It will be understood that these components can be provided in other arrangements to provide the same functionality described herein. Also, the housing 16 can be made of plastic or another suitable material.

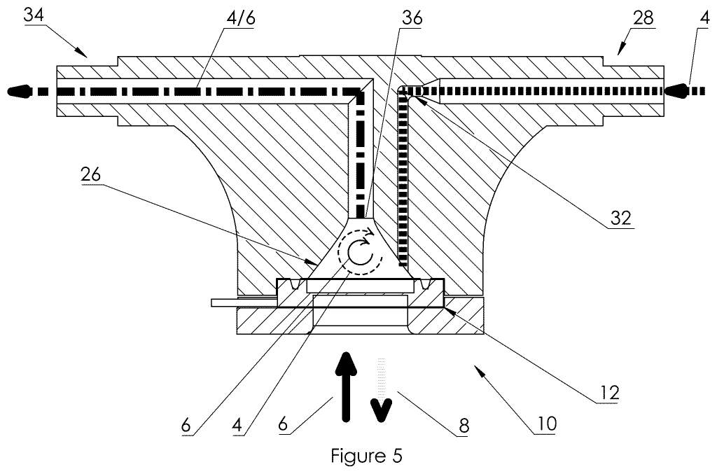

The liquid inlet line 20 includes a liquid intake 28 (e.g., a tubing connector) at its intake end and a liquid discharge 30 at its discharge end. The liquid discharge 30 is positioned at a peripherally outer (side) and lower portion of the collection chamber 26. With the ultrasonic transducer 12 positioned below the collection chamber 26, the liquid discharge 30 thereby delivers water (and/or another liquid) 4 to a peripherally outer and upper portion of the ultrasonic transducer 12 (see FIG. 5). The liquid 4 is delivered into the liquid line intake 28 under positive pressure, as discussed below.

In addition, the liquid inlet line 20 typically includes a flow constriction 32, with the liquid inlet line having a first segment 20a between the liquid intake 28 and the flow constriction 32 that has a larger cross-sectional area than a second segment 20b between the flow constriction 32 and the collection chamber 26. The flow constriction 32 of each misting device 10 throttles the liquid 4 so the ultrasonic transducer 12 of each misting device 10 receives the same volume of liquid (this also increases the flow rate/speed of the liquid 4 flowing onto the ultrasonic transducer 12). The flow constriction 32 is particularly advantageous when the misting nozzle device 10 is used in a system of multiple serially connected nozzle devices, to allow the last nozzle device 10 in line to get close to the same volume of liquid as the first nozzle device in line (as such, the flow constriction may be excluded in systems with one or few nozzle devices).

In other embodiments, the flow constriction is positioned at the liquid intake (e.g., included in a tubing connector, so the entire liquid inlet line has the same cross-sectional area and is smaller than a connected liquid line), is positioned upstream of the housing as a separate component, or is not included (with the pressure and flow rate set and/or controlled by other devices).

The liquid drain line 22 includes a drain liquid outlet 34 (e.g., a tubing connector) at its outlet end and a liquid intake 36 at its intake end. The liquid intake 36 is positioned at the top of the collection chamber 26 (e.g., centered at an apex of a tapered collection chamber). In this way, the liquid 4 that is feed by the liquid inlet line 20 to the ultrasonic transducer 12, but that is not converted into the mist 8 by the ultrasonic transducer 12, and that is infused with air bubbles by the ultrasonic transducer 12 (i.e., air bubbles emitted from the top side of the vibrating mesh ultrasonic transducer) to form an aerated liquid 4/6, is directed into the drain line intake 26 under the force of the liquid pressure from the liquid inlet line 20.

The bottom opening 24 is positioned at the bottom of the housing 16 so that the mist 8 generated by ultrasonic transducer 12 flows downward under the force of gravity. The bottom opening 24 provides fluid communication between the collection chamber 26 (above it) and the ambient target area (below it, targeted for humidification, etc.). The perforations of the ultrasonic transducer 12 are selected to be sufficiently fine/small, and the pressure of the liquid 4 delivered to the ultrasonic transducer 12 is selected to be sufficiently low, that the pressurized liquid 4 does not pass downward through the ultrasonic transducer 12 and out of the bottom opening 24. At the same time, the perforations of the ultrasonic transducer 12 are selected to be sufficiently large that air (and/or other gasses) 4 can pass upward through the ultrasonic transducer 12 and into the collection chamber 26 during operational use (high-frequency oscillations) of the ultrasonic transducer 12 to generate the fine mist of liquid droplets 8, and those fine-mist liquid droplets can then pass downward through the ultrasonic transducer 12 and out of the bottom opening 24 toward the target area. For example, the sufficiently low pressure of the liquid 4 delivered to the ultrasonic transducer 12 (into the collection chamber 26 at the liquid discharge 30) can be about 0.5 psi to about 5.0 psi (e.g., about 1.5 psi to about 3.0 psi, typically about or below 2.0 psi). A pressure regulator (e.g., as described below) can be integrated into or connected to the nozzle device 10 to provide this sufficiently low liquid pressure at the liquid discharge 30, if the liquid pressure at the liquid intake 28 is higher than needed to provide the described functionality.

It should be noted that the embodiments disclosed herein are described in an orientation with the mist 8 emitted downward through the bottom opening 24 and with the air-bubble-infused liquid 4/6 rising upwards from the ultrasonic transducer 12 through the collection chamber 26, as this orientation provides excellent results. It will be understood that this orientation is done for convenience in describing these embodiments, and references to bottom, top, etc. are thus for convenience and not limiting/required of the invention. Thus, these and other embodiments can be installed in other orientations, with modifications as may be needed, and used to provide the same functionality described herein, for example with the mist 8 emitted laterally or angularly.

In the depicted embodiment, the collection chamber 26 has bottom and top cross-sectional areas (e.g., parallel to the plane of the ultrasonic transducer 12), with the bottom area 38 being larger than the top area 40, and with a peripheral sidewall 42 that extends between the bottom and top areas 38 and 40 and that is tapered inwardly and upwardly. The larger bottom area 38 is adjacent and in fluid communication with the ultrasonic transducer 12, with the liquid inlet line discharge 30 located at and in fluid communication with a peripheral portion of the larger bottom area 38. And the smaller top area 40 is in fluid communication with the drain intake 36, with the top area 40 located where the drain intake 36 meets the collection chamber 26). Also, the drain intake 36 is located at or adjacent the apex of the tapered collection chamber 26. In typical embodiments, the drain intake 36 and top area 40 are circular, and the ultrasonic transducer 12 and bottom area 38 are circular, with the drain intake 36 centered and coaxial relative to the collection chamber 26 and the ultrasonic transducer 12. The tapered collection chamber 26 is thus configured to provide a space where the air bubbles (generated atop and by the ultrasonic transducer 12) can mix with the remaining liquid (not converted into mist) and thereby be carried away (induced/influenced to flow, under the positive pressure of the liquid) from atop the ultrasonic transducer 12 and toward the drain intake 36 so the air bubbles do not sit atop and clog the ultrasonic transducer 12 (the circular arrows within the collection chamber 26 in FIG. 5 indicate mixing of liquid 4 and air bubbles 6 into aerated liquid 4/6, and not necessarily the actual flow paths).

The sidewall 42 can be provided by a single continuous wall or multiple wall segments, and can define the collection chamber 26 with a shape that is conical (including frustoconical, as depicted) and thus linear in cross section, dome-shaped and thus curved in cross section, stepped and thus rectilinear in cross section, pyramidal (e.g., with a triangular or rectangular bottom area 38 and transducer 12) and thus linear in cross section, or of another configuration (including polygonal and other regular and irregular shapes) that provides the described functionality. The depicted conical shape of the chamber 26 helps funnel the aerated liquid upward within the collection chamber and away from the ultrasonic transducer 12. As noted, the tapered collection chamber 26 functions to collect the remaining liquid 4 and the generated air bubbles 6, mix them into the drain liquid (e.g., aerated water and/or other liquid) 4/6, and direct/guide and carry it upward and away from the ultrasonic transducer 12 under the pressure of the flowing liquid 4 into the drain intake 36. In this way, the drain liquid 4/6 does not accumulate and pool on top of the ultrasonic transducer 12, which pooling would interfere with transducer operation to generate the fine mist of droplets 8.

In other embodiments, the collection chamber has other configurations. For example, the collection chamber can be cylindrical or have another regular or irregular non-tapered shape that provides a space for the air bubbles (created and infused into the drain liquid by the ultrasonic transducer) to move away from the ultrasonic transducer to avoid pooling and thereby “clogging” or “jamming” the ultrasonic transducer in a way that impairs its performance. In some such other embodiments, the collection chamber includes one or more sharp-tipped spikes (e.g., extending downward from an upper surface portion and into a middle portion of the chamber) that burst the air bubbles. In other such embodiments, the misting device (e.g., the liquid inlet line) includes smoother turns to help keep bubbles from congregating. And in these and./or other embodiments, a control can be provided (e.g., included in the control unit) that regularly cycles the ultrasonic transducer off for a brief time period (e.g., 5-10 seconds) to allow the air bubbles to dissipate and then back on to resume misting operation.

In addition, in typical embodiments, the liquid line discharge 30 (and the liquid inlet segment 20b) has a smaller cross-sectional area than the drain line intake 36 (and the drain line 22). In this way, there is a higher fluid flowrate at the liquid line discharge 30 (into the collection chamber 26) than at the drain line intake 36 (out of the collection chamber 26). The liquid 4 entering the collection chamber 26 at a higher flowrate than the flowrate of the aerated liquid 4/6 exiting the collection chamber 26 causes the liquid to displace the air bubbles from atop the ultrasonic transducer 12. This helps induce the aerated drain liquid 4/6 (that does not pass downward through the ultrasonic transducer 12 and out the bottom opening 24 as mist droplets 8) to flow upward through the collection chamber 26 and out of the drain line 22, instead of pooling on top of the ultrasonic transducer 12.

Further, the liquid line discharge 30 delivers the liquid 4 into the collection chamber 26 at the bottom periphery of the collection chamber 26, and the drain line intake 36 receives the drain liquid 4/6 at or adjacent the top (e.g., conical apex) of the collection chamber 26, as noted above. The periphery is the radially outward portion of the collection chamber bottom, as depicted. In use, the liquid 4 is caused to flow through the liquid line discharge 30 into the bottom area 38 of the collection chamber 26, by the positive liquid pressure, and across the ultrasonic transducer 12 from its periphery radially inward towards its center. At the same time, air 6 is caused to flow generally vertically upward from the bottom opening 24 through the ultrasonic transducer 12 and into the bottom area 38 of the collection chamber 26, by high-frequency (e.g., 108 kHz to 115 kHz) vibratory oscillating/pulsing operation of the ultrasonic transducer 12. The vibratory operation of the ultrasonic transducer 12 then causes interaction between the air 6 and liquid 4 in the bottom area 38 of the collection chamber 26 (immediately on top of the ultrasonic transducer 12) to form the mist of fine liquid droplets 8 and the air-infused aerated drain liquid 4/6 (the water and/or other liquid that is not vaporized/atomized by the transducer 12). Then the fine mist 8 is expelled downward through the ultrasonic transducer 12 and out the bottom opening 24 to the target area, while the aerated drain liquid 4/6 flows generally vertically upward away from the ultrasonic transducer 12 to collect and flow through the top area 40 of the collection chamber 26 and into the drain line intake 36. In this way, the peripheral bottom position of the liquid line discharge 30 and the top central position of the drain line intake 36 help induce the aerated drain liquid to flow upward through the collection chamber 26 and out of the drain line 22, instead of pooling on top of the ultrasonic transducer 12.

Some of the air bubbles 6 in the collection chamber 26 might be expelled back through the ultrasonic transducer 12 and back out the bottom opening 24 (e.g., in orientations with the mist 8 emitted upwards or laterally), but this is not significant to functioning of the misting device 10. In any event, the result is the mist cloud of fine droplets 8 is projected downwards and outwards (e.g., about 3 feet to about 4 feet in typical embodiments), dispersing over the target (e.g., food products) and increasing the humidity of the target environment area.

In the depicted embodiment, the liquid inlet line 20b is substantially vertical (and thus substantially parallel to the drain line 34 at the drain line intake 40) and the liquid line discharge 30 is directed downward to deliver the liquid 4 downward into the periphery of the larger bottom area 38 of the collection chamber 26. In other embodiments, the liquid inlet line 20b (least the portion adjacent the chamber bottom periphery forming the liquid discharge) is substantially horizontal (and thus substantially perpendicular to the drain line 34 at the drain line intake 40 and parallel to the vibrating mesh transducer) and the liquid line discharge 30 is directed radially inward to deliver the liquid laterally into the periphery of the larger bottom area 38 of the collection chamber 26. In some such embodiments, the liquid inlet line (least the portion adjacent the chamber bottom periphery forming the liquid discharge) is arranged tangentially to the chamber bottom or otherwise not aligned through the center of the chamber bottom in order to induce a whirlpool flow in the chamber. Other arrangements of the liquid line discharge 30 can be used to help induce the aerated drain to flow upward through the collection chamber 26 and out of the drain line 22, instead of pooling on top of the ultrasonic transducer 12.

A number of the misting nozzle devices 10 can be combined into a misting system that delivers the generated mist 8 to the target area. In some embodiments, the misting devices 10 are mounted in place directly (e.g., to a display case) and connected to directly (e.g., by liquid feed, liquid drain, and power lines). In other embodiments, the misting devices 10 are mounted in place and connected to indirectly, with one or more of the devices 10 incorporated into a misting module that is then directly mounted in place and directly connected to.

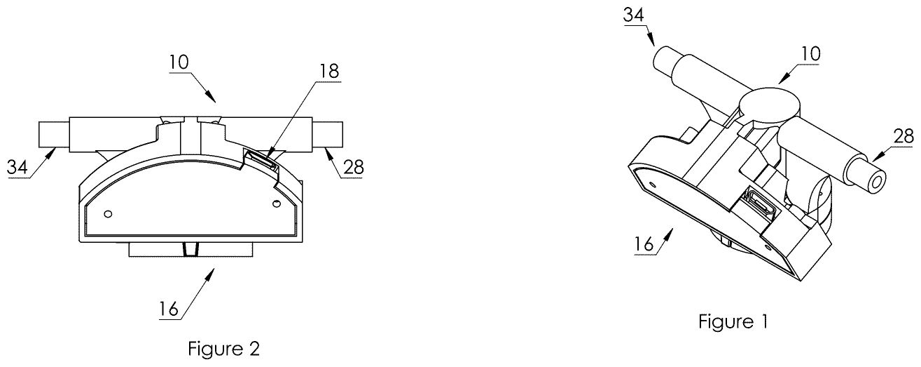

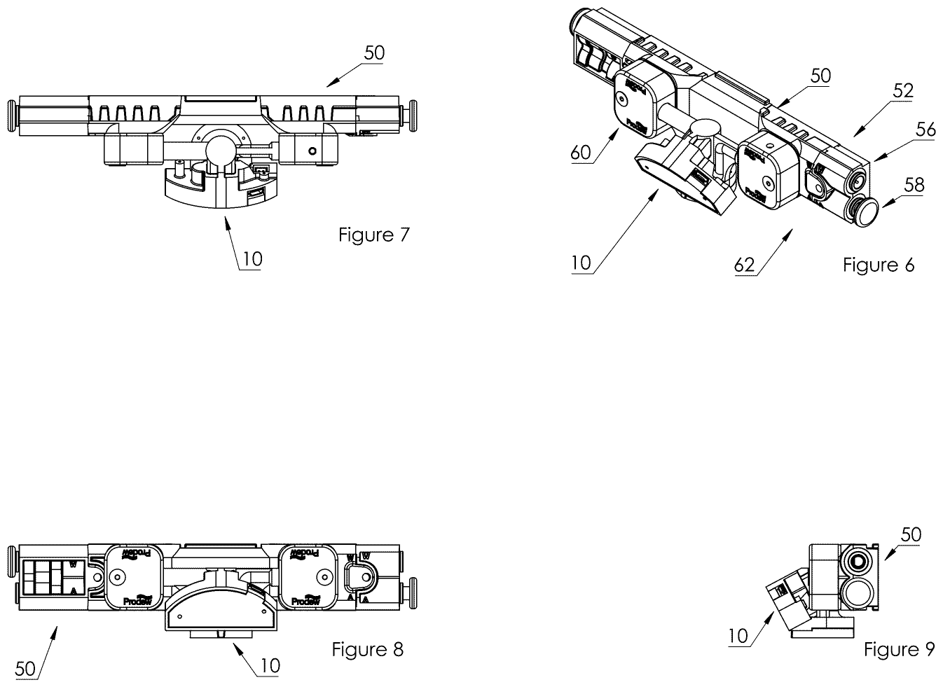

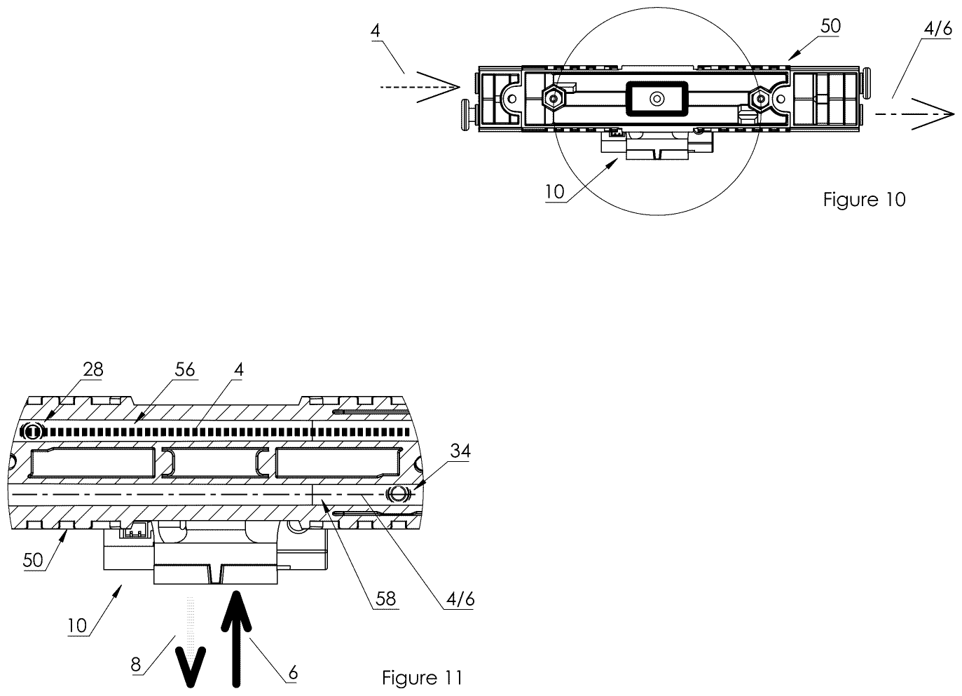

For example, FIGS. 6-11 shows a misting module 50 including one of the misting devices 10. The misting module 50 can be of the type disclosed by U.S. Pat. No. 11,493,215, issued Nov. 8, 2022, which is hereby incorporated herein by reference. In the depicted embodiment, the misting module 50 is a modular adaptation of the fog-generation system 60 shown and described with reference to FIGS. 2-7 of the '215 Patent. As such, the depicted misting module 50 includes a fluid delivery bar 52 with two fluid lumens (channels/headers) 56 and 58, with each lumen connected in fluid communication with a respective manifold 60 and 62. The misting nozzle device 10 is connected in fluid communication between the two manifolds 60 and 62 (in place of the sprayer nozzle 76 of the '215 Patent), with one of the lumens and manifolds feeding the liquid to the misting nozzle device 10 (as in the '215 Patent), and with the other lumen and manifold draining the aerated liquid drain from the drain outlet 34 (instead of feeding the air to the sprayer 76 of the '215 Patent). Thus, in the depicted embodiment, air is drawn in through the ultrasonic transducer 12 (instead of through the air lumen 64 and manifold 74 of the '215 Patent), so instead of the lumens and manifolds both being feed/intake lines, one is a feed/intake and the other is a drain.

It will be understood that the misting device 10 can be incorporated into other misting modules, including other adaptations of the embodiments disclosed by the '215 Patent as well as other embodiments.

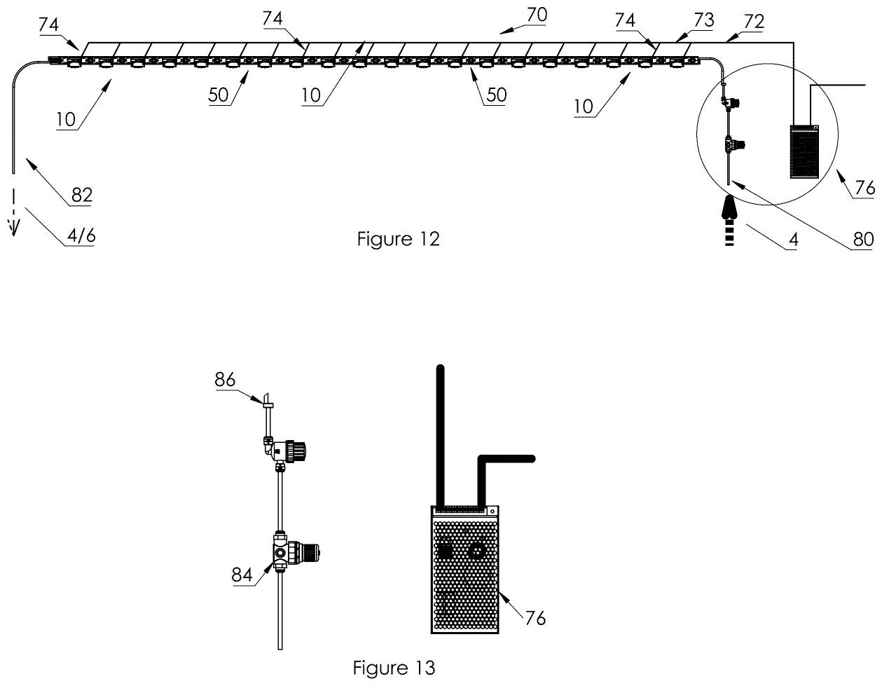

Turning now to FIGS. 12-13, there is shown a misting system 70 according to another embodiment, including a plurality of the misting devices 10 to provide the misting functionality described herein. In this embodiment, the misting devices 10 are incorporated into the herein-described misting modules 50, which are connected together end-to-end into an integrated and continuous track of the misting devices 10. The track of misting devices 10 can be installed for example in the canopy of a produce display case, or the upper interiors of meat and seafood display cases. The misting devices 10 can be provided in a number and spacing selected for the intended target area (e.g., display case).

The misting system 70 includes electric power wiring to the misting devices 10. For example, electric power can be connected to the misting devices 10 by a wiring harness 73, including a single trunk electric power wire 72 and an individual electric power wire running from the trunk line 72 to the electrical connection 18 of each misting device 10. Thus, even though there are a large number of the misting devices 10, and conventional design would dictate a single centralized control unit and a large number of individual control wires from the central control unit out to the misting devices 10, instead each misting device 10 has its own control unit 14 that is fed by only a power wire, with the local/dedicated control units 14 eliminating the need for individual control wires out to each misting device 10.

Also, the electric power wiring can be connected to standard 120/240 v power supplied by the local electric utility, and a transformer 76 can be connected in line to step down the power to the desired level (e.g., 5 vDC) for the control unit 14. The single trunk electric power wire 72 and the individual service electric power wires 72 can thus be provided by conventional low-voltage electric wires.

The misting system 70 also includes a water (and/or other liquid) feed line 80 and a drain line 82. The feed and drain lines 80 and 82 can be provided by conventional tubing connected directly or indirectly to the liquid line intake 28 and the drain line outlet 34. A pressure regulator 84 and/or a dripper 86 can be included in the feed line 80 to control the pressure and/or flowrate of the liquid 4 fed to the misting devices 10. For example, in typical embodiments, the pressure regulator 84 can operate to reduce the positive liquid pressure to an operating level between about 0.5 psi and about 5.0 psi (e.g., about 1.5 psi to about 3.0 psi, typically about or below 2.0 psi) and to maintain it there during use (city water systems often deliver tap water at 40 psi to 60 psi, and sometimes up to about 80 psi), to provide the functionality described herein. The dripper 86 is typically positioned inline after the pressure regulator 84. The dripper 86 functions to output a uniform liquid flow rate, regardless of the liquid pressure, as this helps ensure proper operation of the ultrasonic transducers 12. Depending on the size of the misting system 70, the dripper 86 can be selected with a size/capacity of for example 1 gallons/hour (GPH), 2 GPH, or 5 GPH. These pressure-control and flow-control components can be of a conventional type known in the field, for example, the dripper 86 can be a pressure-compensating dripper of the type used in agricultural irrigation systems. It will be understood that other components can be included to control the liquid pressure to provide the misting functionality and avoid the aerated liquid pooling on top of the ultrasonic transducers 12, as described above.

Also, the downstream end of the liquid feed line 80 is plugged, and the upstream end of the liquid drain line 82 is plugged, because these lines are not configured in a closed loop. In other embodiments, the liquid feed is supplied to both ends of the feed line and the drain line is open at both ends.

In addition, the liquid feed line 80 is connected to a liquid supply, typically a conventional water tab with the water supplied by a local water utility. Thus, the water supply is under positive pressure, which pushes the feed liquid 4 through the feed line 80 to the misting devices 10, and pushes the aerated drain liquid 4/6 out of the misting devices 10 and through the drain line 82. So a liquid pump is not needed (as a component of the system) to provide positive liquid pressure (with the pump running forward) or to provide negative/vacuum liquid pressure (with the pump running in reverse), and a liquid reservoir is not needed as the liquid supply. Furthermore, typical local water supplies operate at positive water pressures of about 40 psi to about 60 psi., so the pressure regulator 84 and/or dripper 86 can be selected to reduce the positive liquid pressure to the desired operating pressures of the systems 70.

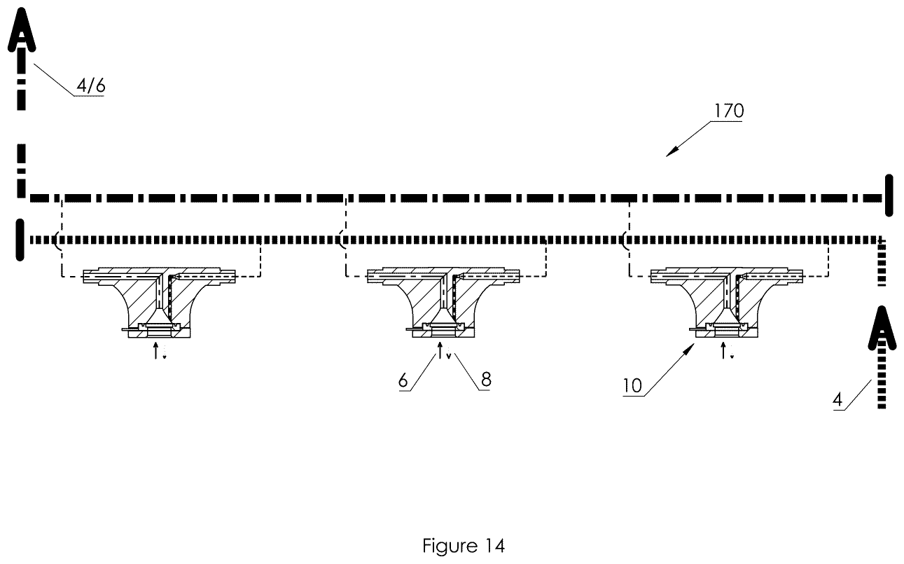

Turning now to FIG. 14, there is shown an open-loop (non-circulatory) misting system 170 according to another embodiment, including a plurality of the misting devices 10 to provide the misting 8 and functionality described herein. This figure shows schematically the flow of the feed liquid 4 and the aerated drain liquid 4/6 through the misting devices 10 in an open-loop configuration including a water (and/or other liquid) feed line with an upstream end connected to a positive-pressure source (e.g., pressurized city water or a pump) and a downstream end plugged, and with a drain line with an upstream open end and a downstream plugged end.

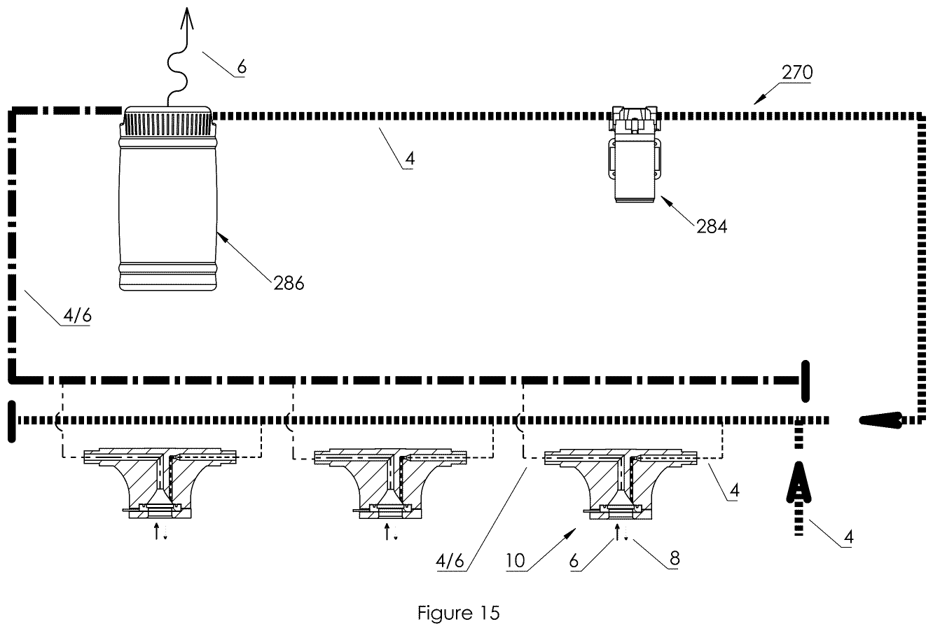

Turning now to FIG. 15, there is shown a closed-loop (recirculatory) misting system 270 according to another embodiment, including a plurality of the misting devices 10 to provide the misting 8 and functionality described herein. This figure shows schematically the flow of the feed liquid 4 and the aerated drain liquid 4/6 through the misting devices 10 in a closed-loop configuration including a water (and/or other liquid) pump 284 and a drain tank 286. The liquid pump 284 provide the positive liquid pressure (instead of pressurized city water) and the drain tank 286 eliminates the air bubbles 6 from the aerated drain liquid 4/6.

Accordingly, the various embodiments provide various advantages over the prior art, for example the following. One area of advantage results in embodiments in which each individual nozzle has its own control board. This enables routing a single electric supply line to each nozzle, instead of having multiple control lines from a centralized controller to the nozzles. This also allows flexibility in having a variety of nozzles, because there is not a central controller. And this further allows including an individual electric switch on each device 10 for individual nozzle turn off without effecting the performance of the other nozzles.

Another area of advantage results in embodiments having two (e.g., parallel) liquid lines, with one a supply line and with the other a drain line that discards the liquid not used by the nozzles as well as the air bubbles produced by the nozzles during the process of creating the misting fog. This eliminates the need for recirculation of water (or other liquids) through a centralized reservoir.

Another advantage is safety. At least some embodiments use water directly from the plumbing system, with or without a reverse osmosis water purification equipment or any other water filtration equipment. Additional disinfecting material can optionally be injected into the water, if desired. There is no need for a pressure pump or circulating pump. There is no need for a reservoir of any kind, especially the kind where the water is exposed to the atmosphere enabling bacteria to grow, for example the bacteria causing Legionnaires' disease. And there is no standing water in the delivery pipes.

Another advantage is low water and/or other liquid consumption. For at least some embodiments, a misting system including about 23 nozzles consumes about 1 gallon of water per hour.

Another advantage is simple and easy use. For at least some embodiments with individual power switches for each misting device, it is simple and easy to turn off individual nozzles.

Another advantage is simple and easy installation and maintenance. For at least some embodiments, each nozzle has its own electronic control board that controls the ultrasonic vibration of the mesh of that nozzle, so only a single power line to all of the individual nozzles is needed. Also, the replacement of nozzles is simple and easy.

Another advantage is liquid-droplet size. For at least some embodiments, the liquid droplets are about 3 microns, which is similar to many conventional ultrasonic fog-misting systems.

Another advantage is no need for filtration. For at least some embodiments, reverse osmosis or other purification is not necessary, however it may still be recommended in certain applications.

Another advantage is cost. For at least some embodiments, the cost is considerably lower than conventional ultrasonic fog-misting systems.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the specific sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An ultrasonic misting nozzle device for generating a mist, comprising:
an ultrasonic transducer; and
a housing including a liquid inlet line discharge, a drain outlet line intake, a mist opening, and a collection chamber, wherein collection chamber includes a bottom and a top, wherein the drain outlet line intake connects to the collection chamber top, and the liquid inlet line discharge connects to the collection chamber bottom, which is adjacent and above the ultrasonic transducer, which is adjacent and above the mist opening,
wherein in operation a liquid flows under pressure from the liquid inlet line discharge and into the collection chamber bottom, the ultrasonic transducer operates to induce a gas to flow upward into the mist opening, through the ultrasonic transducer, and into the collection chamber bottom, and the ultrasonic transducer generates gas bubbles in the collection chamber bottom and emits the mist downward out of the collection chamber through the ultrasonic transducer and the mist opening, and
wherein the liquid flows under pressure across and atop the ultrasonic transducer to displace the gas bubbles from atop the ultrasonic transducer and mix with the gas bubbles to form a gas-infused liquid that flows upward within the collection chamber, away from the ultrasonic transducer, and out of the collection chamber through the drain outlet.

2. The ultrasonic misting nozzle device of claim 1, wherein the liquid includes water and the gas includes air.

3. The ultrasonic misting nozzle device of claim 2, wherein the ultrasonic transducer is a vibrating-mesh ultrasonic transducer.

4. The ultrasonic misting nozzle device of claim 1, wherein the liquid inlet line discharge is connected to the collection chamber bottom at a periphery thereof, wherein in operation the liquid flows into the collection chamber bottom inwardly from the periphery.

5. The ultrasonic misting nozzle device of claim 4, wherein the collection chamber is tapered with the collection chamber bottom being larger than the collection chamber top to funnel the gas-infused liquid upward within the collection chamber and away from the ultrasonic transducer.

6. The ultrasonic misting nozzle device of claim 5, wherein the tapered collection chamber has conical shape.

7. The ultrasonic misting nozzle device of claim 4, wherein the drain outlet line intake connects to the collection chamber top at an apex thereof.

8. The ultrasonic misting nozzle device of claim 7, wherein the drain outlet line intake is centrally located above and axially aligned with the collection chamber bottom.

9. The ultrasonic misting nozzle device of claim 1, wherein the liquid inlet line discharge has a smaller cross-sectional area than the drain outlet line intake, wherein the liquid enters the collection chamber at a higher flowrate than the flowrate of the gas-infused liquid exiting the collection chamber to induce the liquid to displace the air bubbles from atop the ultrasonic transducer.

10. The ultrasonic misting nozzle device of claim 1, further comprising a liquid inlet line connected to the liquid inlet line discharge, wherein the liquid inlet line includes a flow constriction that decreases pressure of the liquid entering the collection chamber so the liquid is not forced downward through the ultrasonic transducer and out the misting opening.

11. The ultrasonic misting nozzle device of claim 1, further comprising a liquid inlet line connected to the liquid inlet line discharge and a drain outlet line connected to the drain outlet line intake, wherein the liquid inlet line is substantially vertical and substantially parallel to the drain outlet line.

12. The ultrasonic misting nozzle device of claim 1, further comprising a control unit that controls the operation of the ultrasonic transducer.

13. An ultrasonic misting system, comprising:
a plurality of the ultrasonic misting nozzle devices of claim 12; and
low-voltage electric power wiring to each of the control units.

14. The ultrasonic misting system of claim 13, further comprising a feed line connected to the liquid inlet line intakes of the ultrasonic misting nozzle devices, wherein the feed line is connected to and fed by a supply of the liquid under positive pressure.

15. The ultrasonic misting system of claim 14, wherein the plurality of ultrasonic misting nozzles are all connected to the same feed line and are all connected to a common drain line.

16. An ultrasonic misting nozzle device for generating a mist, comprising:
an ultrasonic transducer; and
a housing including a liquid inlet line discharge, a drain outlet line intake, a mist opening, and a collection chamber, wherein collection chamber includes a bottom and a top, wherein the drain outlet line intake connects to the collection chamber top, and the liquid inlet line discharge connects to the collection chamber bottom, which is adjacent and above the ultrasonic transducer, which is adjacent and above the mist opening,
wherein the liquid inlet line discharge is connected to the collection chamber bottom at a periphery thereof, wherein the drain outlet line intake connects to the collection chamber top at an apex thereof, and wherein the collection chamber is tapered with the collection chamber bottom being larger than the collection chamber top to funnel the gas-infused liquid upward within the collection chamber and away from the ultrasonic transducer,
wherein in operation a liquid including water flows under pressure from the liquid inlet line discharge and into the collection chamber bottom radially inward from the periphery, the ultrasonic transducer operates to induce air to flow upward into the mist opening, through the ultrasonic transducer, and into the collection chamber bottom, and the ultrasonic transducer generates air bubbles in the collection chamber bottom and emits the mist downward out of the collection chamber through the ultrasonic transducer and the mist opening, and
wherein the liquid flows under pressure across and atop the ultrasonic transducer to displace the air bubbles from atop the ultrasonic transducer and mix with the air bubbles to form an air-infused liquid that flows upward within the collection chamber, away from the ultrasonic transducer, and out of the collection chamber through the drain outlet.

17. The ultrasonic misting nozzle device of claim 16, wherein the ultrasonic transducer is a vibrating-mesh ultrasonic transducer.

18. The ultrasonic misting nozzle device of claim 16, wherein the liquid inlet line discharge has a smaller cross-sectional area than the drain outlet line intake, wherein the liquid enters the collection chamber at a higher flowrate than the flowrate of the gas-infused liquid exiting the collection chamber to induce the liquid to displace the air bubbles from atop the ultrasonic transducer.

19. The ultrasonic misting nozzle device of claim 16, further comprising a liquid inlet line connected to the liquid inlet line discharge, wherein the liquid inlet line includes a flow constriction that decreases pressure of the liquid entering the collection chamber so the liquid is not forced downward through the ultrasonic transducer and out the misting opening.

20. The ultrasonic misting nozzle device of claim 16, further comprising a control unit that controls the operation of the ultrasonic transducer.
